(19) United States
(12) Patent Application Publication
(10) Pub. No.: US 2017/0342323 A1
(43) Pub. Date: Nov. 30, 2017

(54) ETCHANT

(71) Applicant: Nagase ChemteX Corporation, Osaka (JP)

(72) Inventors: Satoru YOSHIZAKI, Hyogo (JP); Yoshihiro MUKAI, Hyogo (JP)

(21) Appl. No.: 15/606,947

(22) Filed: May 26, 2017

(30) Foreign Application Priority Data
May 31, 2016 (JP) 2016-108908

(51) Int. Cl. C09K 13/00; C08K 5/42; C08K 5/092

(52) U.S. Cl. CPC C09K 13/00; C08K 5/092; C08K 5/42

(57) ABSTRACT

The present invention provides an etchant which is usable for a long period of time owing to its high indium solubility and reduced precipitation of a salt of oxalic acid and indium, and further has excellent residue removal and antifoaming properties, thereby being suitable for etching indium oxide-based films. An etchant for etching an indium oxide-based film, the etchant containing: (A) oxalic acid; (B) polyvinylpyrrolidone; and (C) water.

### TECHNICAL FIELD

The present invention relates to an etchant for etching an indium oxide-based film.

### BACKGROUND ART

Display devices such as liquid crystal displays (LCDs) and electroluminescent (EL) displays include transparent conductive films as pixel display electrodes, for example. Indium oxide-based transparent conductive films, e.g. indium tin oxide (ITO) films, have been widely used as the transparent conductive films. For example, an ITO film is formed on a substrate (e.g. glass) by a deposition process such as sputtering. Then, the ITO film is etched using, for example, a resist mask to form an electrode pattern on the substrate. Such etching processes include wet and dry processes. Wet processes employ etchants.

Conventional processes for wet etching a polycrystalline ITO film typically use strong acids such as hydrochloric acid which can cause corrosion of components such as aluminum interconnects during etching and also allow etching to occur preferentially at the ITO grain boundaries so that it is difficult to pattern such a material with high machining accuracy.

In this context, a technique has recently been developed which uses an amorphous ITO film as a transparent conductive film, and a weak acid, in particular, an aqueous oxalic acid solution, to etch the film. This technique, however, has a problem in that etching residues remain on the substrate after the ITO film is etched with the aqueous oxalic acid solution. Another problem is that when a surfactant such as dodecylbenzenesulfonic acid is added to the etchant to solve the above problem, the formation of etching residues can be reduced, but significant foaming of the etchant can occur. Significant foaming may push up the substrate, and the occurrence of foaming on the substrate inhibits etchant contact, thereby hindering etching. In either case, accurate etching cannot be accomplished, possibly resulting in defects in interconnection patterns.

Meanwhile, especially in the field of LCDs, an undercoat film such as a silicon nitride (SiN) film or an organic film is formed on a glass substrate, and then an amorphous ITO film is formed on the undercoat film. Such a SiN film is used, e.g., to prevent contamination of metallic impurities from the glass substrate, while such an organic film is used, e.g., to flatten the aperture region and improve the aperture ratio. However, when an ITO film formed on such an undercoat film is etched, etching residues can be more easily formed than when an ITO film formed on a substrate with no undercoat film is etched. It may therefore be difficult to sufficiently remove such residues using a conventional etchant.

Still another problem is that common oxalic acid-based etchants, which have an indium solubility of about 200 ppm, allow a salt of oxalic acid and indium to precipitate as a solid as the etching proceeds. In the fabrication of electronic components where even particles smaller than 1 μm cause a problem, such solid precipitation is a critical problem. Moreover, the precipitated salt may clog the filter provided for circulation of the treatment solution, thereby requiring an expensive replacement cost. For this reason, such etchants need to be replaced before the salt is precipitated, even if they still sufficiently function as etchants. Consequently, these etchants unfortunately have a short life.

Patent Literatures 1 and 2, for example, disclose etchants that solve the above problems. They are oxalic acid-based etchants containing a naphthalenesulfonic acid condensate as a surfactant. However, these etchants still provide insufficient residue removal, and therefore leave room for improvement.

### CITATION LIST

### Patent Literature

Patent Literature 1: JP 4674704 B

Patent Literature 2: JP 2011-49602 A

### SUMMARY OF INVENTION

### Technical Problem

The present invention aims to provide an etchant which is usable for a long period of time owing to its high indium solubility and reduced precipitation of a salt of oxalic acid and indium, and further has excellent residue removal and antifoaming properties, thereby being suitable for etching indium oxide-based films.

### Solution to Problem

The inventors have made extensive studies to solve the above problems, and have found that an etchant as disclosed in Patent Literatures 1 and 2, but using polyvinylpyrrolidone (PVP) as the surfactant instead of the naphthalenesulfonic acid condensate, provides improved residue removal, thereby completing the present invention.

Specifically, the etchant of the present invention is an etchant for etching an indium oxide-based film, the etchant containing: (A) oxalic acid; (B) polyvinylpyrrolidone; and (C) water.

In the etchant of the present invention, the polyvinylpyrrolidone (B) is preferably present in an amount of 0.01 to 1 wt %.

The etchant of the present invention preferably further contains (D) a naphthalenesulfonic acid condensate. Also, the polyvinylpyrrolidone (B) and the naphthalenesulfonic acid condensate (D) are preferably present in a ratio of (B):(D) of 100:1 to 0.5:100 by weight.

The etchant of the present invention preferably further contains (E) an alkaline component. The alkaline component (E) is preferably at least one selected from the group consisting of ammonia, water-soluble alkylamines, water-soluble alkanolamines, and quaternary alkylammoniums.

The etchant of the present invention preferably has a viscosity of 0.5 to 50 mPa·s.

### Advantageous Effects of Invention

The etchant of the present invention, which contains (A) oxalic acid, (B) polyvinylpyrrolidone, and (C) water, is usable for a long period of time owing to its high indium solubility and reduced precipitation of a salt of oxalic acid and indium, and further has excellent residue removal and antifoaming properties, thereby being suitable for etching indium oxide-based films.

### DESCRIPTION OF EMBODIMENTS

### <<Etchant>>

The etchant of the present invention is for etching an indium oxide-based film and contains: (A) oxalic acid; (B) polyvinylpyrrolidone; and (C) water.

### <(A) Oxalic Acid>

The oxalic acid (A) functions as an etching agent for indium oxide in the etchant of the present invention. The amount of oxalic acid (A) in the etchant of the present invention is, but is not limited to, equal to or less than the amount soluble in the water (C), and preferably in the range of 0.5 to 15 wt %, more preferably 1 to 7 wt %. An amount of oxalic acid (A) of less than 0.5 wt % may lead to an insufficient etching rate, while an amount of more than 15 wt % may exceed the soluble amount, causing precipitation.

In the present invention, the oxalic acid (A) refers to oxalic acid present in the etchant of the present invention, and does not mean that oxalic acid itself needs to be used as a raw material to prepare the etchant of the present invention. The etchant of the present invention therefore encompasses an etchant prepared using as a raw material a salt of oxalic acid (A) and the later-described alkaline component (E), for example. Specifically, an etchant prepared using tetramethylammonium oxalate as a raw material contains the oxalic acid (A) and tetramethylammonium as the alkaline component (E). When a salt of components (A) and (E) is used, the respective component contents can be calculated in light of the molecular weights of the respective ions. For example, in the case of bistetramethylammonium oxalate, it is considered that component (A) constitutes 37% of the weight of the salt added and component (E) constitutes 63% thereof.

### <(B) Polyvinylpyrrolidone>

The polyvinylpyrrolidone (B) functions as a surfactant in the etchant of the present invention. The amount of polyvinylpyrrolidone (B) in the etchant of the present invention may preferably be, but is not limited to, 0.005 to 2 wt %, more preferably 0.01 to 1 wt %, still more preferably 0.05 to 0.5 wt %, for example. An amount of polyvinylpyrrolidone (B) of less than 0.005 wt % may lead to insufficient residue removal, while an amount of more than 2 wt % may lead to an increased viscosity.

The polyvinylpyrrolidone (B) may have any K value, but preferably has a K value of 10 to 60. A K value of less than 10 or more than 60 may lead to insufficient residue removal. The term “K value” as used herein refers to a viscous characteristic value that correlates with the molecular weight.

### <(C) Water>

The amount of water (C) in the etchant of the present invention is, but is not limited to, the remaining amount obtained by excluding the above-described components (A) and (B) and the later-described other components. The amount of water (C) may preferably be 60 to 99.5 wt %, more preferably 90 to 99.5 wt %, for example.

The etchant of the present invention may contain any other component in addition to the oxalic acid (A), polyvinylpyrrolidone (B), and water (C). Non-limiting examples of other components include: (D) a naphthalenesulfonic acid condensate; (E) an alkaline component; (F) hydrochloric acid; (G) an antifoaming agent; a surfactant other than components (B) and (D); sulfuric acid; a corrosion inhibitor; and an organic solvent. These components may be used alone or in combination.

### <(D) Naphthalenesulfonic Acid Condensate>

The naphthalenesulfonic acid condensate (D) functions as a surfactant similarly to the polyvinylpyrrolidone (B) in the etchant of the present invention. The etchant of the present invention preferably contains the naphthalenesulfonic acid condensate (D) because the combined use of polyvinylpyrrolidone (B) and naphthalenesulfonic acid condensate (D) is effective to further improve residue removal.

The naphthalenesulfonic acid condensate (D) may be a condensate of β-naphthalenesulfonic acid or a salt thereof with formaldehyde or other compounds. Examples of the salt of β-naphthalenesulfonic acid include, without limitation, sodium salts, potassium salts, ammonium salts, monoethanolamine salts, and triethanolamine salts. The molecular weight of the naphthalenesulfonic acid condensate (D) is preferably, but not limited to, 1000 to 5000. Commercially available products that can be used as the naphthalenesulfonic acid condensate (D) include, for example, LAVELIN FM-P, LAVELIN FH-P (both available from DKS Co. Ltd.), MX-2045L (available from Kao Corporation), and POLITY N-100K (available from Lion corporation). These products may be used alone or in combination.

The amount of naphthalenesulfonic acid condensate (D) in the etchant of the present invention is preferably, but not limited to, 0.005 to 5 wt %, more preferably 0.01 to 1 wt %. An amount of naphthalenesulfonic acid condensate (D) of less than 0.005 wt % may be insufficiently effective to further improve residue removal, while an amount of more than 5 wt % may lead to insufficiently improved residue removal and a reduced etching rate.

In the etchant of the present invention, the ratio of polyvinylpyrrolidone (B) to naphthalenesulfonic acid condensate (D) ((B):(D)) is preferably, but not limited to, 100:1 to 0.5:100 by weight. When the ratio is out of the range indicated above, the combined use of both components may be less likely to be effective to improve residue removal.

### <(E) Alkaline Component>

The precipitation of a salt of oxalic acid (A) and indium can be reduced by incorporating the alkaline component (E) into the etchant of the present invention. Examples of the alkaline component (E) include, without limitation, water-soluble alkanolamines such as monoethanolamine, monoisopropanolamine, N-propanolamine, monomethylethanolamine, diethanolamine, N-methyldimethanolamine, and triethanolamine; ammonia; water-soluble alkylamines such as methylamine, ethylamine, propylamine, dimethylamine, diethylamine, dipropylamine, trimethylamine, triethylamine, and tripropylamine; quaternary alkylammoniums such as tetramethylammonium hydroxide (TMAH); hydroxylamines; water-soluble alkali metals; and salts of the foregoing (e.g. hydrochlorides, sulfates, or carbonates of amines, and hydrochlorides, sulfates, or carbonates of ammonium). For prevention of metal contamination, preferred among these is at least one selected from the group consisting of ammonia, water-soluble alkylamines, water-soluble alkanolamines, and quaternary alkylammoniums. In particular, monoethanolamine or N-methyldimethanolamine is preferred. These alkaline components (E) may be used alone or in combination. Component (E) may be ionized in the etchant.

When the etchant of the present invention contains the alkaline component (E), the amount of alkaline component (E) is preferably, but not limited to, 0.5 to 20 wt %, more preferably 1 to 10 wt %. An amount of alkaline component (E) of less than 0.5 wt % may lead to an insufficient capability of reducing precipitation of a salt of oxalic acid (A) and indium, while an amount of more than 20 wt % may lead to a disadvantage in residue removal or a decrease in etching rate.

In the present invention, the alkaline component (E) refers to an alkaline component present in the etchant of the present invention, and does not mean that an alkaline component needs to be used a raw material to prepare the etchant of the present invention. The etchant of the present invention therefore encompasses an etchant prepared using as a raw material a salt of oxalic acid (A) and alkaline component (E), for example.

### <(F) Hydrochloric Acid>

The precipitation of a salt of oxalic acid (A) and indium can be reduced by incorporating the hydrochloric acid (F) into the etchant of the present invention.

When the etchant of the present invention contains the hydrochloric acid (F), the amount of hydrochloric acid (F) is preferably, but not limited to, 0.01 to 0.3 wt %. An amount of hydrochloric acid (F) of less than 0.01 wt % may lead to an insufficient capability of reducing precipitation of a salt of oxalic acid and indium, while an amount of more than 0.3 wt % may lead to insufficient residue removal.

### <(G) Antifoaming Agent>

Antifoaming properties can be improved by incorporating the antifoaming agent (G) into the etchant of the present invention. Examples of the antifoaming agent (G) include, without limitation, lower alcohols and polyoxyalkylene alkyl ethers. These antifoaming agents (G) may be used alone or in combination.

When the etchant of the present invention contains the antifoaming agent (G), the amount of antifoaming agent (G) is preferably, but not limited to, 0.00001 to 0.1 wt %. An amount of antifoaming agent (G) of less than 0.00001 wt % may lead to insufficient antifoaming properties, while an amount of more than 0.1 wt % may cause deformation of the resist.

The etchant of the present invention may have any viscosity, for example a viscosity of 200 mPa·s or lower, preferably 0.5 to 50 mPa·s. The etchant with a viscosity of higher than 50 mPa·s may fail to be spread sufficiently uniformly on the substrate, resulting in an etching defect. In general, the term “etching paste” often refers to one having a viscosity of 300 mPa·s or higher. The term “viscosity” as used herein refers to a value measured at room temperature (e.g. 25° C.)

The etchant of the present invention can be prepared by mixing (with stirring at room temperature) the components described above by an ordinary method.

The etchant of the present invention is used to etch an indium oxide-based film formed on a substrate (e.g. glass) by sputtering or other techniques, thereby enabling patterning. The etchant of the present invention is also suitable for etching an indium oxide-based film formed on an undercoat film which in turn is formed on a substrate. Examples of the indium oxide-based film include, without limitation, indium tin oxide (ITO) films, indium zinc oxide (IZO) films, and indium gallium zinc oxide (IGZO) films. The term “undercoat film” as used herein refers to a film which is formed on a substrate prior to the formation of an indium oxide-based film and on which the indium oxide-based film is formed. Examples of the undercoat film include, without limitation, silicon nitride (SiN) films and organic films. SiN films are used, e.g., to prevent contamination of metallic impurities from the glass substrate, while organic films are used, e.g., to flatten the aperture region and improve the aperture ratio.

The etchant of the present invention can be used at room temperature or with heating, e.g. at 25° C. to 50° C. The etching duration required varies depending on the conditions such as the thickness of the indium oxide-based film, but is typically about 1 to 30 minutes, for example. The etched substrate may be washed in a rinsing step, as needed.

The etchant of the present invention may be brought into contact with the indium oxide-based film by any method, such as by showering, immersion, immersion with shaking, or US immersion.

In an exemplary application where the etchant of the present invention may be used, a substrate made of a material such as a semiconductor, glass, or resin, an undercoat film, an indium oxide-based film, and a resist serving as a mask are stacked in the given order to give a stack, and the resist is patterned and then used as a mask to etch the indium oxide-based film with the etchant of the present invention. This stack may include an insulating film, metal interconnect, TFT, or other components, if necessary, between the substrate and the indium oxide-based film and/or between the indium oxide-based film and the resist. Examples of the metal constituting the metal interconnect include, without limitation, Cu, Al, Mo, Ti, Zr, Mn, Cr, Ca, Mg, and Ni. These metals may be used alone or in combination. The resist may be a known one which may be either a positive or negative resist.

### EXAMPLES

The present invention is described with reference to examples below. The examples, however, are not intended to limit the scope of the present invention. Hereinafter, the terms “part(s)” and “%” refer to “part(s) by weight” and “wt %”, respectively, unless otherwise specified.

### Comparative Examples 1 to 14, Examples 1 to 20

The components shown in the following Table 1 in the respective amounts (wt %) were mixed to obtain an etchant (total: 100 wt %). The etchants thus prepared were evaluated for indium (In) solubility, residue removal, antifoaming properties, and viscosity by the later-described methods. The results are shown in Table 2.

### (Evaluation Method)

### 1. Indium (in) Solubility

An Erlenmeyer flask was charged with the etchant prepared in each of the examples and comparative examples and then with indium oxide. After a reflux condenser was attached to the flask, the mixture was boiled with stirring for four hours. After completion of the boiling, the mixture was cooled at 25° C. for 48 hours. Then, the precipitation of a supersaturated indium compound was confirmed, followed by filtration of the mixture through a filter having a pore size of 0.2 μm. The filtrate was collected, and the indium concentration in the filtrate was measured by ICP optical emission spectrometry. The results were evaluated based on the following criteria.

Excellent: 1300 ppm or more
Good: at least 800 ppm but less than 1300 ppm
Fair: at least 300 ppm but less than 800 ppm
Poor: less than 300 ppm

### 2. Residue Removal

### 2-1. On Organic Film

An organic film was formed on a glass substrate, and an ITO film was then formed on the organic film. This substrate was subjected to etching for a period of time that was 1.4 times the just etching time calculated from the etching rate. The etched sample was rinsed with water, blown with nitrogen, and then observed with an electron microscope. The residues after etching were evaluated based on the criteria below.

### 2-2. On Silicon Nitride (SiN) Film

A silicon nitride (SiN) film was formed on a glass substrate, and an ITO film was then formed on the silicon nitride film. This substrate was subjected to etching for a period of time that was 1.4 times the just etching time calculated from the etching rate. The etched sample was rinsed with water, blown with nitrogen, and then observed with an electron microscope. The residues after etching were evaluated based on the following criteria.

Excellent: very small amount
Good: small amount
Fair: large amount
Poor: very large amount

### 3. Antifoaming Properties

An amount of 30 ml of the etchant prepared in each of the examples and comparative examples was placed in a 100 ml colorimetric tube, which was then mounted on a TS shaker and shaken for two minutes. The shaking was stopped, and one minute later, the foaming height (mm) was measured. The results were evaluated based on the criteria below. Here, a foaming height of 5 mm or shorter means substantially no foaming and does not hinder the operation of the etching device; a foaming height of higher than 5 mm but 15 mm or shorter means slight foaming but does not substantially hinder the operation of the etching device. However, a foaming height of higher than 15 mm means foaming which is likely to hinder the operation of the device.

### Excellent: 0 mm

Good: higher than 0 mm but 5 mm or shorter
Fair: higher than 5 mm but 15 mm or shorter
Poor: higher than 15 mm

### 4. Viscosity

The viscosity of the etchant prepared in each of the examples and comparative examples was measured at 25° C. with a Cannon-Fenske viscometer.

TABLE 1

| | | | | | | | Surfactant | | | | |
|---|---|---|---|---|---|---|---|---|---|---|---|
| | | Salt of | | | | Naphthalene | other | | | | |
| | | (A) | | | | sulfonic | than | | | Anti- | |
| | | oxalic acid | | | Polyvinyl- | acid | components | | Hydro- | foaming | |
| | Oxalic | and | Alkaline | | pyrrolidone | condensate | (B) | | chloric | agent | |
| | acid | (E) | component | | (B) | (D) | and | | acid | (G) | Water |
| | (A) | TMA | (E) | | PVP | NSF | (D) | | (F) | POA | (C) |
| Comparative | 3.0 | 0.0 | MEA | 2.5 | 0.0 | 0 | ABS | 0.2 | 0.05 | 0 | Balance |
| Example 1 | | | | | | | | | | | |
| Comparative | 3.0 | 0.0 | MEA | 2.5 | 0.0 | 0 | NS | 0.2 | 0.05 | 0 | Balance |
| Example 2 | | | | | | | | | | | |
| Comparative | 3.0 | 0.0 | MEA | 2.5 | 0.0 | 0 | NMP | 0.2 | 0.05 | 0 | Balance |
| Example 3 | | | | | | | | | | | |
| Comparative | 3.0 | 0.0 | MDA | 3.0 | 0.0 | 0 | ABS | 0.2 | 0.05 | 0 | Balance |
| Example 4 | | | | | | | | | | | |
| Comparative | 3.0 | 0.0 | MDA | 3.0 | 0.0 | 0 | NS | 0.2 | 0.05 | 0 | Balance |
| Example 5 | | | | | | | | | | | |
| Comparative | 3.0 | 0.0 | MDA | 3.0 | 0.0 | 0 | NMP | 0.2 | 0.05 | 0 | Balance |
| Example 6 | | | | | | | | | | | |
| Comparative | 3.0 | 0.0 | MEA | 2.5 | 0.0 | 0.2 | — | 0 | 0.05 | 0 | Balance |
| Example 7 | | | | | | | | | | | |
| Comparative | 3.0 | 0.0 | MDA | 3.0 | 0.0 | 0.2 | — | 0 | 0.05 | 0 | Balance |
| Example 8 | | | | | | | | | | | |
| Comparative | 3.0 | 0.0 | MEA | 2.5 | 0.0 | 0.2 | ABS | 0.2 | 0.05 | 0 | Balance |
| Example 9 | | | | | | | | | | | |
| Comparative | 3.0 | 0.0 | MEA | 2.5 | 0.0 | 0.2 | MS | 0.2 | 0.05 | 0 | Balance |
| Example 10 | | | | | | | | | | | |
| Comparative | 3.0 | 0.0 | MEA | 2.5 | 0.0 | 0.2 | NMP | 0.2 | 0.05 | 0 | Balance |
| Example 11 | | | | | | | | | | | |
| Comparative | 3.0 | 0.0 | MDA | 3.0 | 0.0 | 0.2 | ABS | 0.2 | 0.05 | 0 | Balance |
| Example 12 | | | | | | | | | | | |
| Comparative | 3.0 | 0.0 | MDA | 3.0 | 0.0 | 0.2 | NS | 0.2 | 0.05 | 0 | Balance |
| Example 13 | | | | | | | | | | | |
| Comparative | 3.0 | 0.0 | MDA | 3.0 | 0.0 | 0.2 | NMP | 0.2 | 0.05 | 0 | Balance |
| Example 14 | | | | | | | | | | | |
| Example 1 | 3.0 | 0.0 | MEA | 2.0 | 0.2 | 0 | — | 0 | 0.20 | 0 | Balance |
| Example 2 | 3.0 | 0.0 | MEA | 2.0 | 0.2 | 0 | — | 0 | 0.00 | 0 | Balance |
| Example 3 | 3.0 | 0.0 | MDA | 3.0 | 0.2 | 0 | — | 0 | 0.05 | 0 | Balance |
| Example 4 | 3.0 | 0.0 | TMAH | 3.0 | 0.2 | 0 | — | 0 | 0.05 | 0 | Balance |
| Example 5 | 2.0 | 3.0 | — | 0.0 | 0.2 | 0 | — | 0 | 0.05 | 0 | Balance |
| Example 6 | 3.0 | 0.0 | MEA | 2.5 | 0.1 | 0.1 | — | 0 | 0.05 | 0 | Balance |
| Example 7 | 3.0 | 0.0 | MDA | 3.0 | 0.1 | 0.1 | — | 0 | 0.20 | 0 | Balance |
| Example 8 | 3.0 | 0.0 | MDA | 3.0 | 0.1 | 0.1 | — | 0 | 0.05 | 0 | Balance |
| Example 9 | 3.0 | 0.0 | MDA | 3.0 | 0.1 | 0.1 | — | 0 | 0.00 | 0 | Balance |
| Example 10 | 3.0 | 0.0 | TMAH | 3.0 | 0.1 | 0.1 | — | 0 | 0.05 | 0 | Balance |
| Example 11 | 2.0 | 3.0 | — | 0.0 | 0.1 | 0.1 | — | 0 | 0.05 | 0 | Balance |
| Example 12 | 3.0 | 0.0 | MEA | 2.5 | 0.3 | 0.5 | — | 0 | 0.05 | 0 | Balance |
| Example 13 | 3.0 | 0.0 | MDA | 3.0 | 0.3 | 0.5 | — | 0 | 0.05 | 0 | Balance |
| Example 14 | 3.0 | 0.0 | MEA | 2.5 | 0.3 | 0.2 | — | 0 | 0.05 | 0.001 | Balance |
| Example 15 | 3.0 | 0.0 | MDA | 3.0 | 0.3 | 0.2 | — | 0 | 0.05 | 0.001 | Balance |
| Example 16 | 3.0 | 0.0 | TMAH | 3.0 | 0.3 | 0.2 | — | 0 | 0.05 | 0.001 | Balance |
| Example 17 | 2.0 | 3.0 | — | 0.0 | 0.3 | 0.2 | — | 0 | 0.05 | 0.001 | Balance |
| Example 18 | 3.0 | 0.0 | MEA | 2.5 | 0.3 | 0.2 | — | 0 | 0.05 | 0.001 | Balance |
| Example 19 | 3.0 | 0.0 | MDA | 3.0 | 0.3 | 0.2 | — | 0 | 0.05 | 0.001 | Balance |
| Example 20 | 5.0 | 0.0 | MDA | 3.0 | 0.3 | 0.2 | — | 0 | 0.05 | 0.001 | Balance |

In Table 1, the abbreviations represent the following compounds. PVP used had a K value in the range of 10 to 60. Salt of oxalic acid and TMA: bis-tetramethylammonium oxalate

### MDA: N-methyldiethanolamine

MEA: monoethanolamine
TMAH: tetramethylammonium hydroxide
PVP: polyvinylpyrrolidone
NSF: naphthalenesulfonic acid-formaldehyde condensate
ABS: alkylbenzenesulfonate
NS: naphthalenesulfonate

### NMP: N-methylpyrrolidone

POA: polyoxyalkylene alkyl ether

TABLE 2

| | In | Residue removal | | Anti- | |
|---|---|---|---|---|---|
| | solubility | Organic | SiN | foaming | Viscosity |
| | (ppm) | film | film | properties | (mPa · s) |
| Comparative | Excellent | Good | Poor | Poor | 1.0 |
| Example 1 | | | | | |
| Comparative | Excellent | Good | Poor | Excellent | 1.0 |
| Example 2 | | | | | |
| Comparative | Excellent | Poor | Poor | Excellent | 1.0 |
| Example 3 | | | | | |
| Comparative | Excellent | Good | Poor | Poor | 1.0 |
| Example 4 | | | | | |
| Comparative | Excellent | Good | Poor | Excellent | 1.0 |
| Example 5 | | | | | |
| Comparative | Excellent | Poor | Poor | Excellent | 1.0 |
| Example 6 | | | | | |
| Comparative | Excellent | Excellent | Fair | Good | 1.0 |
| Example 7 | | | | | |
| Comparative | Excellent | Excellent | Fair | Good | 1.0 |
| Example 8 | | | | | |
| Comparative | Excellent | Excellent | Fair | Poor | 1.0 |
| Example 9 | | | | | |
| Comparative | Excellent | Excellent | Fair | Good | 1.0 |
| Example 10 | | | | | |
| Comparative | Excellent | Excellent | Fair | Good | 1.0 |
| Example 11 | | | | | |
| Comparative | Excellent | Excellent | Fair | Poor | 1.0 |
| Example 12 | | | | | |
| Comparative | Excellent | Excellent | Fair | Good | 1.0 |
| Example 13 | | | | | |
| Comparative | Excellent | Excellent | Fair | Good | 1.0 |
| Example 14 | | | | | |
| Example 1 | Excellent | Excellent | Good | Excellent | 1.0 |
| Example 2 | Good | Excellent | Good | Excellent | 1.0 |
| Example 3 | Excellent | Excellent | Good | Excellent | 1.0 |
| Example 4 | Excellent | Excellent | Good | Excellent | 1.0 |
| Example 5 | Excellent | Excellent | Good | Excellent | 1.0 |
| Example 6 | Excellent | Excellent | Excellent | Good | 1.0 |
| Example 7 | Excellent | Excellent | Excellent | Good | 1.0 |
| Example 8 | Excellent | Excellent | Excellent | Good | 1.0 |
| Example 9 | Excellent | Excellent | Excellent | Good | 1.0 |
| Example 10 | Excellent | Excellent | Excellent | Good | 1.0 |
| Example 11 | Excellent | Excellent | Excellent | Good | 1.0 |
| Example 12 | Excellent | Excellent | Excellent | Good | 1.0 |
| Example 13 | Excellent | Excellent | Excellent | Good | 1.0 |
| Example 14 | Excellent | Excellent | Excellent | Excellent | 1.0 |
| Example 15 | Excellent | Excellent | Excellent | Excellent | 1.0 |
| Example 16 | Excellent | Excellent | Excellent | Excellent | 1.0 |
| Example 17 | Excellent | Excellent | Excellent | Excellent | 1.0 |
| Example 18 | Excellent | Excellent | Excellent | Excellent | 1.0 |
| Example 19 | Excellent | Excellent | Excellent | Excellent | 1.0 |
| Example 20 | Excellent | Excellent | Excellent | Excellent | 1.0 |

As shown in Table 2, the inventive etchants of Examples 1 to 20 containing (A) oxalic acid and (B) polyvinylpyrrolidone exhibited excellent residue removal not only on an organic film but also on a SiN film while maintaining In solubility and antifoaming properties. In contrast, the etchants of Comparative Examples 1 to 14 containing no polyvinylpyrrolidone exhibited inferior residue removal, particularly on the SiN film.

1. An etchant for etching an indium oxide-based film, the etchant comprising:
(A) oxalic acid;
(B) polyvinylpyrrolidone; and
(C) water.

2. The etchant according to claim 1,
wherein the polyvinylpyrrolidone (B) is present in an amount of 0.01 to 1 wt %.

3. The etchant according to claim 1, further comprising
(D) a naphthalenesulfonic acid condensate.

4. The etchant according to claim 3,
wherein the polyvinylpyrrolidone (B) and the naphthalenesulfonic acid condensate (D) are present in a ratio of (B):(D) of 100:1 to 0.5:100 by weight.

5. The etchant according to claim 1, further comprising
(E) an alkaline component.

6. The etchant according to claim 5,
wherein the alkaline component (E) is at least one selected from the group consisting of ammonia, water-soluble alkylamines, water-soluble alkanolamines, and quaternary alkylammoniums.

7. The etchant according to claim 1, which has a viscosity of 0.5 to 50 mPa·s.
